(19) United States
(12) Patent Application Publication
(10) Pub. No.: US 2008/0170401 A1
(43) Pub. Date: Jul. 17, 2008

(54) Decorative Lamp

(76) Inventor: Xuliang Li, Dongguan (CN)

Correspondence Address: GLOBAL IP SERVICES, 7285 W. Eagle Court, Winton, CA, 95388, US

(21) Appl. No.: 11/769,949

(22) Filed: Jun. 28, 2007

(30) Foreign Application Priority Data
Jan. 17, 2007 (CN) 200720118116.0

(51) Int. Cl. F21V 7/10

(52) U.S. Cl. 362/296

(57) ABSTRACT

The present invention relates in general to a decorative lamp, and more particularly to a modeling decorative lamp which has a lighting body and a support frame shaped into a model. A plurality of flat bars which are twisted into spiral shapes are fixed on the support frame and compose a modeling surface of the model. The lighting body is fixed within a cavity of the model. The flat bars are coated with a layer of reflective material. Therefore, the decorative lamp with a specific model is capable of producing different flashing effect while seen from different angle.

### CROSS REFERENCE TO THE RELATED PATENT APPLICATION

This application claims the priority of the Chinese patent application No. 200720118116.0, filing date of Jan. 17, 2007.

### FIELD OF THE INVENTION

The present invention relates in general to a decorative lamp, and more particularly to a modeling decorative lamp.

### BACKGROUND OF THE INVENTION

Decorative lamps are gaining a wider and wider popularity nowadays, especially on festivals. Generally, the decorative lamp used at present comprises a lighting body and a support frame. The lighting body is arranged within a mid-cavity of the support frame or bound to the support frame. In addition, a layer of colorful gauze, glass or PVC (polyvinyl chloride) film wraps around the support frame. Chinese patent NO. 200520008743.X discloses a decorative lamp that has a modeling steel shelf, a lighting body, and wires for connecting the lighting body to power source. The lighting body is disposed on the modeling steel shelf which is covered with a layer of vacuum-formed transparent PVC film. The prior decorative lamps including the decorative lamp disclosed in CN Patent NO. 200520008743.X are monotonous in vision and accordingly not capable of providing imagination, thereby they are insufficient to fully exhibit model fidelity and lack of aesthetic sense.

### SUMMARY OF THE INVENTION

Accordingly, an object of the present invention is to provide a decorative lamp with a specific model which enables to produce different flashing effect while seen from different angle to overcome the disadvantages existing in the prior art.

To achieve the above-mentioned object, the present decorative lamp comprises a lighting body and a support frame shaped into a model. A plurality of flat bars which are twisted into spiral shapes are fixed on the support frame and compose a modeling surface of the model. The lighting body is fixed within a cavity of the model. The flat bars are coated with a layer of reflective material.

Alternatively, the lighting body is light bulb, and the light bulb is electrically connected to a power source via wires and a switch.

Preferably, the support frame is formed by another plurality of flat bars that are twisted into spiral shapes, and the support frame is coated with a layer of reflective material.

Alternatively, the flat bar is iron flat bar formed by twisting an iron strip.

Also alternatively, the flat bars are attached to the support frame by butt jointing.

Preferably, the reflective material is glitter and coated on surfaces of the flat bars.

In the embodiment, the model of the support frame is a combinatory model combined by several detachable modeling units, and each flat bar is fixed on only one modeling unit.

Alternatively, the model of the support frame is selected from shapes of mouse, cow, tiger, rabbit, dragon, snake, horse, sheep, monkey, chicken, dog, pig, deer, bird, fish, duck, goose, elephant, lion, tree and banana.

In comparison with the prior art, as the spiral flat bars of the decorative lamp of the present invention are designed to be coated with a layer of reflective material, the flat bars possesses different reflecting surfaces at different angle, which assist the decorative lamp to produce different flashing effect when seen from different angle. With regards to the imaginative modeling lamp of deer, angel and so on, the flashing effect enables the decorative lamp to possess a vivid effect and therefore improves imagination on the modeling.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. I is a elevation view of a flat bar of a decorative lamp of an embodiment according to the present invention, showing the flat bar before twisted;

FIG. 2 is a elevation view of the flat bar after twisted;

FIG. 3 is a perspective view of the decorative lamp comprising the flat bar shown in FIG. 2; and

FIG. 4 is an exploded view of the decorative lamp of FIG. 3.

### DETAILED DESCRIPTION OF ILLUSTRATED EMBODIMENTS

The invention will be described in more detail with reference to the accompanied drawings.

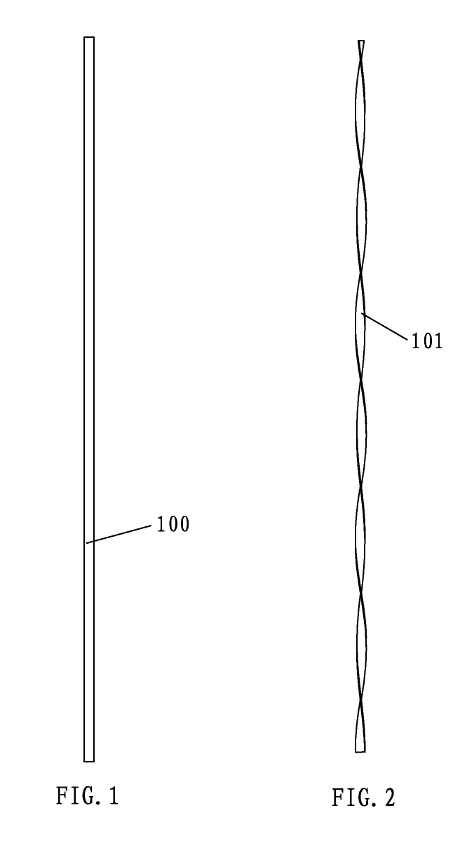

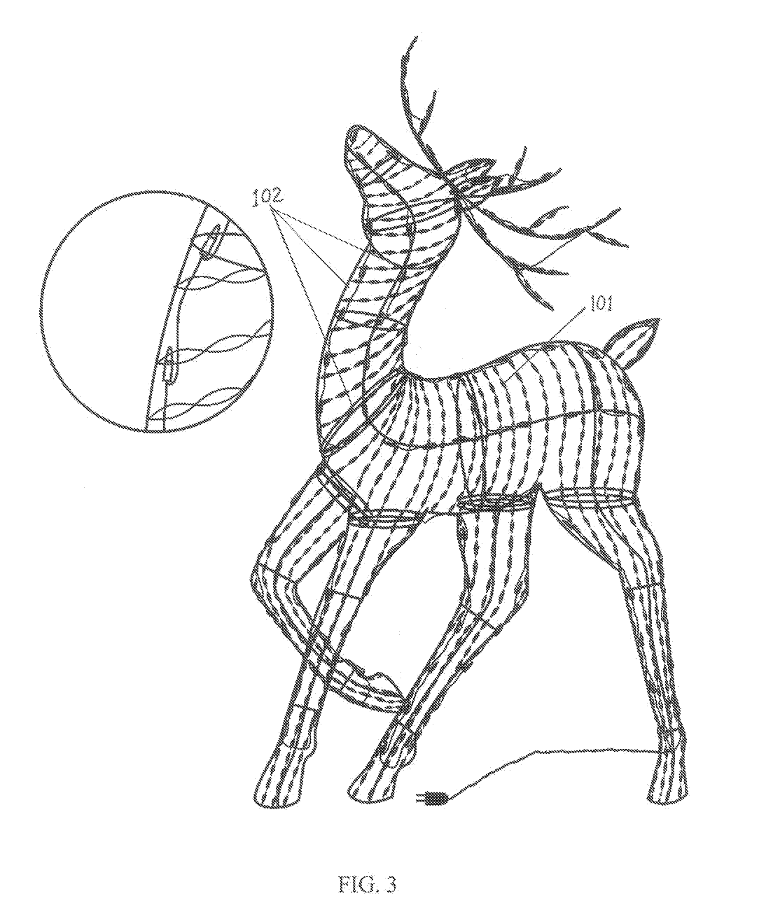

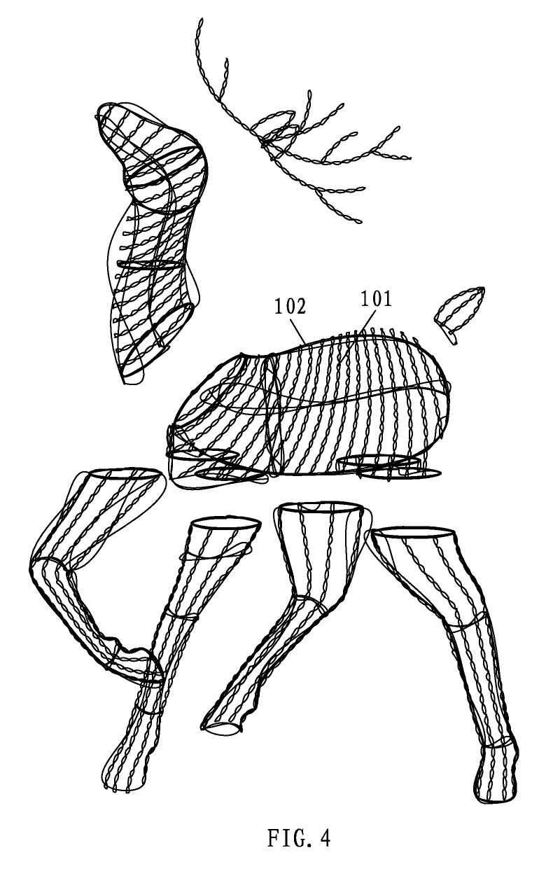

FIGS. 1-4 show a decorative lamp of a preferred embodiment of the present invention.

The embodiment is a detachable deer-modeling decorative lamp. The decorative lamp comprises a lighting body and a support frame 102 shaped into a deer model. The lighting body is light bulb. Specifically, the light bulb is electrically connected with a power source via wires and a switch and suspended within a hollow cavity of the deer model (not shown). A plurality of flat bars 101 which are twisted into spiral shapes are fixed on the support frame 102 and compose a modeling surface of the deer model. The flat bar 101 is iron flat bar formed by twisting an iron strip 100. Preferably, the flat bars 101 are coated with a layer of reflective material.

In the embodiment, individual support frame 102 such as antler is also formed by a plurality of flat bars 101 that are twisted into spiral shapes. The support frame 102 of the subject invention is coated with a layer of reflective material. The flat bar 101 is fixed to the support frame 102 by butt jointing. The reflective material is glitter.

The model of the support frame 102 is a combinatory model combined by several detachable modeling units, and each flat bar 101 is fixed on only one modeling unit. The decorative lamp of the subject embodiment is able to be detached into eight modeling units for facilitating package as well as transportation.

In comparison with the prior art, as the spiral flat bars 101 of the decorative lamp of the present invention are designed to be coated with a layer of reflective material, the flat bars 101 possesses different reflecting surfaces at different angle, which assist the decorative lamp to produce different flashing effect when seen from different angle. The flashing effect enables the decorative lamp to possess a vivid effect and therefore improves imagination on the deer model. It is appreciated that, alternatively, the deer model can be replaced by mouse, cow, tiger, rabbit, dragon, snake, horse, sheep, monkey, chicken, dog, pig, deer, bird, fish, duck, goose, elephant, lion, tree, angel or banana model.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A decorative lamp having reflective twisted flat bar comprising:
a lighting body; and
a support frame shaped into a model, a plurality of twisted flat bars having twist thread shape fixed on the support frame and composing a modeling surface of the model;
wherein the lighting body is fixed within a cavity of the model, and the twisted flat bars having twist thread shape are coated with a layer of reflective material.

2. The decorative lamp according to claim 1, wherein the lighting body is light bulb and the light bulb is electrically connected to a power source via wires and a switch.

3. The decorative lamp according to claim 1, wherein the support frame is formed by a plurality of twisted flat bars having twist thread shape coated with a layer of reflective material.

4. The decorative lamp according to claim 1, wherein the twisted flat bar having twist thread shape is a twisted iron flat bar formed by twisting an iron strip.

5. The decorative lamp according to claim 4, wherein the twisted iron flat bars is fixed to the support frame by butt jointing.

6. The decorative lamp according to claim 1, wherein the reflective material is glitter.

7. The decorative lamp according to claim 1, wherein the model of the support frame is a combinatory model combined by several detachable modeling units, and each twisted flat bar having twist thread shape is fixed on only one modeling unit.

8. The decorative lamp according to claim 1, wherein the model of the support frame is selected from shapes of mouse, cow, tiger, rabbit, dragon, snake, horse, sheep, monkey, chicken, dog, pig, deer, bird, fish, duck, goose, elephant, lion, tree and banana.
